(19) United States
(12) Patent Application Publication
(10) Pub. No.: US 2025/0362231 A1
(43) Pub. Date: Nov. 27, 2025

(54) SENSOR HEAD FOR FLUORESCENCE SPECTROSCOPY

(71) Applicant: SCHOTT AG, Mainz (DE)

(72) Inventors: Hubertus RUSSERT, Mainz (DE); Thomas MOHR, Landshut (DE); Robert HETTLER, Landshut (DE); Bernd SCHULTHEIS, Mainz (DE); Stefan WEISER, Mainz (DE)

(73) Assignee: SCHOTT AG, Mainz (DE)

(21) Appl. No.: 18/873,987

(22) PCT Filed: Jun. 15, 2023
(86) PCT No.: PCT/EP2023/066066

§ 371 Date: Dec. 11, 2024

(30) Foreign Application Priority Data
Jun. 20, 2022 (DE) 10 2022 115 272.3

(51) Int. Cl. G01N 21/64

(52) U.S. Cl. CPC G01N 21/645; G01N 2201/08

(57) ABSTRACT

A light transmitting component, in particular for a sensor head or for connection to a coupling light guide is provided, for transmitting electromagnetic radiation, in particular through a wall. The component includes a feed-through coupling element, which is configured for being arranged in a main body or in a wall opening, for incoupling and transmitting the electromagnetic radiation through the feed-through coupling element, in particular through the wall, without divergence. The feed-through coupling element includes a multi core fiber rod (MCR) and is designed with positional offset tolerance so that a lateral positional offset between the feed-through coupling element and a light transmitting component coupled thereto, such as a coupling light guide, of 10 μm or more, results in a relative signal loss of 10% or less.

### FIELD OF THE INVENTION

The present invention relates to a light transmission component for input coupling and transmission of electromagnetic radiation, to the use of a light transmission component for monitoring or optical analysis of a fluid volume, to a wall measurement system and to a feed-through coupling element.

### BACKGROUND AND GENERAL DESCRIPTION OF THE INVENTION

The analysis and observation of fluids such as liquids that are hidden behind a wall is the subject of constant further development. Firstly, existing biological, chemical or physical reagents or samples should be analyzable or observable in a further-improved manner; secondly, there are always new ideas for reagents or samples that should be made amenable to measurement. In this context, a wide variety of different methods of measurement are used to make a large spectrum of information obtainable. Foremost among these in the applicant's scope of activity are the possibilities of optical measurement, on the basis of the applicant's existing product portfolio and application knowledge. Against this background, the present application is concerned with improvement of the optical measurement of a fluid volume, for example a biological sample or chemical mixture, where the measurement can advantageously be conducted without any unwanted influence on the fluid volume-unless the intention is to influence the fluid volume, which is then likewise covered by the subject matter of this application.

A problem with the mounting and use of optical measurement systems against or within a wall, such as that of a vessel or pipe, is always the resistance to the fluids to be measured and the obtainable integrity, and also the obtainable signal quality, which also suffers from the fact that the system typically has to be set up to be resistant and impervious to any escape of fluid.

One aspect of the invention achieves the object of increasing the signal strength or quality obtained for measurements of a fluid volume by comparison with known measurement devices. A further aspect of the invention achieves the object of avoiding or preventing escape of fluid. Yet a further aspect of the invention achieves the object of introducing minimum or zero impairment of the fluid volume to be measured through the measurement system.

The present description presents a light transmission component which is especially suitable or set up for a sensor head or for connection of a coupling light guide. The light transmission component is intended for transmission of electromagnetic radiation. In other words, the light transmission component is made or constructed such that electromagnetic radiation, for example light, a pulse of light or an optical signal, is guidable through the light transmission component. The light transmission component is also preferably set up such that it can be used to transmit the electromagnetic radiation through a wall. The light transmission component may be set up for sensory detection of a property of a fluid disposed in a vessel or pipeline. The light transmission component may be in direct contact with the fluid in sections for this purpose.

For this purpose, the light transmission component comprises a feed-through coupling element set up for arrangement in a main body or in a wall opening. In other words, the feed-through coupling element comes to rest in a main body or an opening of a pipe wall or vessel wall such that it essentially fills or even independently seals the opening. It is possible here for the feed-through coupling element, for example, to have been inserted, vitrified, especially pressure vitrified, or adhesive-bonded into the opening. In other words, it is thus particularly advantageous when the opening is sealed off in a fluid-tight manner from the light transmission component, especially from the feed-through coupling element. It is also possible here for the light transmission component, depending on the application, to have been made gas-tight, or even capable of maintaining sterility. In a further application, the light transmission component may also be hermetically impervious, which can be ascertained, for example, by means of a helium leak rate test. It is likewise preferable here when the light transmission component seals the wall opening in a fluid-tight manner in vessels or pipes as such, or else in a gas-tight, sterile or hermetic manner.

The feed-through coupling element is especially suitable for input coupling and transmission of the electromagnetic radiation, i.e. has, for example, one or more light-guiding bodies, especially one or more glass bodies, in order preferably to conduct the electromagnetic radiation such as light, an optical measurement signal or an optical pulse through the wall. The feed-through coupling element is preferably selected and set up such that the electromagnetic radiation such as light is conducted through it in a divergence-free manner. Divergence-free transmission of light or electromagnetic radiation, in accordance with the idea of radiation optics, is especially considered to mean transport of light without distance-dependent enlargement of the beam cross section, as, for example, in light guides such as glass fibers.

The feed-through coupling element is preferably designed to be tolerant to positional offset. Tolerance of positional offset has the feature that signal loss in the case of inexact overlap or coverage between the feed-through coupling element and an optical component coupled thereto, such as a coupling light guide, is comparatively small, and in particular much smaller than in known devices. For example, tolerance of positional offset in particular fields of use may possibly form the basis of enabling optical measurement at this measurement site on the wall at all, since existing means attenuated the signal obtained to such an extent that no meaningful evaluation was possible. The tolerance of the feed-through coupling element to positional offset is preferably such that a lateral positional offset between the feed-through coupling element and a light transmission component coupled therewith, such as a coupling light guide, of 10 μm or more, preferably 20 μm or more, further preferably 30 μm or more, results in a relative signal loss of 10% or less, preferably 7% or less, further preferably 5% or less, or else of 3% or less. In other words, in spite of a positional offset, which is considerable for optical scales, for example of 10% or more, preferably 20% or more, or even 30% or more, of the diameter of the feed-through coupling element, an only slightly worsened signal intensity or a virtually similarly large proportion of the electromagnetic radiation can be conducted through the feed-through coupling element. This is by comparison with perfectly centered coupling without positional offset. It may additionally also be designed such that, in the case of a positional offset of 100 μm or less, a considerable proportion of the electromagnetic radiation is still transmissible, preferably of 80 μm or less, further preferably 60 μm or less. Furthermore, the feed-through coupling element may be set up such that the transmission losses or signal loss in the case of one of the aforementioned variances is within an interval that concludes, together with the lower limit for relative signal loss mentioned in the previous paragraph, with an upper limit of 0.5% or more of the original signal magnitude, preferably 2% or more, or else 4% or more of the original signal magnitude. The aforementioned tolerance values are also achievable when the signal pathway through the feed-through coupling element is used in both directions. This is because, in the case of only one coupling direction or only one signal pathway, by the optical principle of “small after large”, it is possible to change to a greater diameter at each coupling point. If, however, both single directions are required, the MCR is also advantageous from this point of view.

A light transmission component, especially for a sensor head or for connection of a coupling light guide, which may preferably comprise some or all of the aforementioned elements, and which is set up to transmit electromagnetic radiation, especially through a wall, in a further execution which is combinable with the above-described execution, comprises a feed-through coupling element set up for arrangement in a main body or in a wall opening for input coupling and transmission of the electromagnetic radiation, especially through the wall. This feed-through coupling element is set up such that it has a numerical aperture for the electromagnetic radiation of 0.21 or greater, preferably 0.25 or greater, more preferably 0.3 or greater, further preferably 0.4 or greater. For example, the numerical aperture may be within a preferred range between 0.5 and 0.6. Alternatively or cumulatively, the feed-through coupling element is set up to have a numerical aperture of 1.2 or less, or else 0.9 or less, preferably 0.8 or less.

A light transmission component, especially for a sensor head or for connection of a coupling light guide, which may preferably comprise some or all of the aforementioned elements, and which is set up to transmit electromagnetic radiation, especially through a wall, in a further execution which is combinable with the above-described execution, comprises a main body which is insertable in a fluid-tight manner into a flange receiver in the wall or is releasably connectable thereto in a fluid-tight manner. The main body has a main body thickness in a direction at right angles to the wall. If, for example, the main body thickness corresponds to the wall thickness and the main body would be inserted flush into the wall, the wall will conclude flush with the main body on the inside and the outside. If the main body thickness is greater than the wall thickness, the main body will surpass the wall on the inside or outside. Any remaining surplus should preferably remain below 200 μm, more preferably below 100 μm, further preferably below 50 μm, most preferably below 10 μm. However, a flush arrangement without any excess is the most favorable. The main body thickness need not be homogeneous over the entire extent of the main body. Particularly advantageously, the thickness of the main body in the region of the opening or receiver for the feed-through coupling element corresponds to, and is in particular measured there as, the main body thickness. If, for example, a flange connection is provided at the wall, for example comprising screw holes for screw connection of the main body, it may then be advantageous to place the main body onto the flange connection from the outside, such that the majority of or the entirety of the main body thickness is outside the wall.

The light transmission component if this design includes the feed-through coupling element inserted into the main body. The feed-through coupling element comes to rest in a main body opening for input coupling and transmission of the optical signal through the main body and hence through the wall. The feed-through coupling element also has a coupling element length in the direction at right angles to the wall and/or in the direction of main body thickness. This main body thickness is identical to the coupling element length, such that the feed-through coupling element inserted into the main body opening does not surpass the main body thickness.

The light transmission component as described in the preceding embodiments may also comprise an optical coupling for connection of the feed-through coupling element to a sensor disposed in the sensor head in particular, where the sensor is especially disposed outside a wall. In other words, the sensor is preferably disposed on the outside of the wall, possibly coupled directly to the feed-through coupling element. The sensor may also be connected to a coupling light guide which is connected at its other end to the feed-through coupling element. It is also conceivable for the sensor to be disposed within the wall together with the feed-through coupling element.

The light transmission component as described in the preceding embodiments, especially the feed-through coupling element, may also be designed to seal the opening in the main body, in the vessel wall or the pipe wall in a fluid-tight, gas-tight, sterile and/or hermetic manner.

The sensor may be set up for sensory detection of a property of a fluid volume. The fluid volume is disposed, for example, in a vessel. A fluid volume disposed in a vessel may be referred to as a fluid volume at rest, although this may also include stirring or any other kind of mixing, agitation or influencing of the fluid volume, since it is essentially at a fixed location. The fluid volume may also be disposed in a pipeline and may especially be a moving or variable fluid volume; it may nevertheless be referred to as such even if the fluid volume in the pipeline is at rest in some sections and is moved through the pipeline at intervals or with varying speed; since the end result is a fluid volume at a variable location. The wall in which the light transmission component is disposed may accordingly, in a preferred case, be a vessel wall or a pipe wall.

The feed-through coupling element has a refractive index. A coupling light guide coupled to the feed-through coupling element also has a refractive index. The coupling light guide that has been coupled on may then have a refractive index different than the feed-through coupling element, which may have, for example, a variance of 10% or more from that of the feed-through coupling element. This results in a broad material selection for the coupling light guide, for example plastic, quartz, multimode fiber or single-mode fiber, or else an light-guiding rod.

There may also be an optical coupling disposed on the feed-through coupling element, possibly even directly on the feed-through coupling element. In one embodiment, a detector or sensor may be disposed directly on the optical coupling of the feed-through coupling element.

In the light transmission component as described in the preceding embodiments, when it has the main body, the main body may have a flange connection for flanging to a counterpart flange connection disposed in the wall.

The light transmission component as described in the preceding embodiments may also comprise a transparent cover, preferably disposed at or, in fluid direction, upstream of an end face of the feed-through coupling element. The transparent cover may have been produced from or may comprise quartz glass or plastic, for example glass, quartz or sapphire. For example, by means of the cover, the light transmission component or the feed-through coupling element may be protected from corrosive media or chemical influences. The cover can also achieve a mechanical protective effect for the light transmission component or the feed-through coupling element.

Additionally or alternatively, a converter element may be included, especially in the form of an organic or ceramic converter. For example, the converter element may be disposed at the end face facing the fluid volume, or upstream in fluid direction. The downstream optical elements, such as feed-through coupling element or coupling light guide, may then be optimized for monochromatic light. Alternatively or cumulatively, it is then possible to use a first optical band A for excitation radiation, and a second band B for detection radiation.

In a particular embodiment, the sensor may alternatively or cumulatively be configured for contact, especially direct contact, with the fluid volume. In this embodiment, the sensor is disposed at or upstream of the end face of the feed-through coupling element for onward transmission of an electromagnetic signal or pulse through the feed-through coupling element.

The electromagnetic radiation may define an optical signal. The electromagnetic radiation may be passed through from the feed-through coupling element into a fluid volume or pass out of the fluid volume into the feed-through coupling element. In addition, the feed-through coupling element may be set up to provide similar optical attenuation for both feed-through directions, wherein the feed-through coupling element is especially of bidirectional design. Alternatively or cumulatively, the feed-through coupling element may be in a broadband setup for transmission of electromagnetic radiation of various wavelengths.

If the light transmission component comprises an optical coupling, this may have one or more of the following properties: the optical coupling is configured to be releasable, it is configured to be non-releasable, it is attached by clamping, it has a screw connection or crimp connection and/or provides separability between the feed-through coupling element and a coupling light guide bonded thereto, and/or the optical coupling enables separable connection of the detector to the feed-through coupling element.

The light transmission component as described in the preceding embodiments may be configured to withstand a fluid pressure. Such a fluid pressure may be applied to the light transmission component by the fluid volume disposed in the vessel or pipe. In particular, the fluid pressure may be 3 bar or more, preferably 5 bar or more. The light transmission component ensures fluid-tightness, especially in respect of sterility, gas-tightness and/or hermeticity.

The feed-through coupling element may have been designed to be tolerant to positional offset such that lateral positional offset between the feed-through coupling element and an optical fiber coupled therewith of 10 μm or more, preferably 20 μm or more, further preferably 30 μm or more, results in a relative signal loss of 10% or less, preferably 7% or less, further preferably 5% or less, or else of 3% or less.

The feed-through coupling element may preferably comprise a flexible individual fiber, a single-core optical fiber rod (SCR) or else a multicore fiber rod (MCR). For example, an SCR or

MCR may have a diameter of 100 μm or greater, or else 150 μm or greater, or else 200 μm or greater. In one variant, the feed-through coupling element may also consist of a flexible individual fiber, an SCR or an MCR. The flexible individual fiber or one individual fiber of the MCR may, for example, have a thickness of 40 μm or less, preferably of 30 μm or less, further preferably of 25 μm or less. The stated thickness typically constitutes the diameter of a individual fiber. The thickness may alternatively or cumulatively be 10 μm or greater, preferably 30 μm or greater, further preferably 50 μm or greater, or else preferably greater than 70 μm.

In one example, the diameter of the individual fiber of the MCR may have an advantageous diameter ratio to the total diameter of the MCR. The diameter ratio between individual fiber and total diameter may, for example, be 1:10 or greater, preferably 1:8+10%, or else 1:7 or less. If, for example, the diameter of the MCR is 200 μm and the diameter of the individual fiber is preferably to be less than ⅛ of the MCR diameter, a particularly preferred diameter of the individual fibers may be in the fiber diameter range from 10 to 20 μm of the individual fibers. If the diameter of the individual fibers were to be chosen within the range of 1:7 or greater, this may result in losses in the marginal region at the transition from the multicore system (MCR) to the coupled fiber (signal return path). The fewer individual fibers are used in the MCR, the higher the percentage proportion of marginal fibers that transmit only partially. On the other hand, the number of fibers is limited, for example, in that the size of the fibers and hence also the cladding thickness falls as the number of fibers increases. If the cladding thickness of the individual fiber goes below a range of about 1 to 2 μm, this can have the effect that the conduction of light by the individual fibers collapses and significant additional losses occur.

It is advantageous here to choose a large enough diameter of the MCR to be able to compensate for all lateral tolerances and, for example, diameter tolerances as well. For instance, it is advantageous when the MCR has a greater diameter than a coupled fiber to be coupled thereto. For example, the diameter of the MCR may be 25% or more greater than the diameter of the coupled fiber, preferably 40% or more, further preferably 50% or more. If, for example, a coupled fiber is to have a core region diameter of 200 μm, the diameter of the active region of the

MCR may be chosen, for example, between 280 μm up to typically 320 μm, or even greater when allowed by the circumstances, for example the installation situation. In the case of an MCR diameter of 300 μm, the result is a maximum offset tolerance of about 50 μm, measured from an offset-free overlap in the direction of the edge, in all lateral directions. In the case of MCR diameter 350 μm, there is a maximum offset tolerance of 75 μm in this regard.

The SCR or the MCR may have a core constituent. Such a core constituent may comprise optical glass for example. The core constituent may consist of a glass composite. Alternatively or cumulatively, the SCR or MCR may have a cladding constituent. For example, the cladding constituent may comprise a cladding glass.

If the MCR includes the core constituent, there may be a difference between core and cladding in the coefficient of thermal expansion (ΔCTE) of the respective material used. For example, this ΔCTE may be not more than 1×10^-6 1/K, preferably 0.5×10^-6 1/K or less and more preferably 0.2×10^-6 1/K or less. If the ΔCTE between core and cladding is close to 0 or equal to 0, i.e. there is a similar or identical CTE between the materials used, this may in turn offer advantages with regard to thermal shock resistance.

Two example systems are presented hereinafter. The first example shall be given the system title “F”.

In system “F”, the core of the feed-through coupling element may have a glass of the following composition: PbO 40-50% by weight; SiO2 40-50% by weight; Na2O 1-10% by weight; K2O 1-10% by weight; and As2O3 less than 1% by weight.

The CTE of the core in system “F” may be 9.1×10^-6 1/K.

In system “F”, the cladding of the feed-through coupling element may have a glass of the following composition: SiO2 55-76% by weight; Al2O3 0-5% by weight; B2O3 0-5% by weight; Li2O+Na2O+K2O together 5-25% by weight; MgO+CaO+SrO+BaO+ZnO together 5-20% by weight; TiO2+ZrO2 together 0-5% by weight; P2O5 0-2% by weight. The CTE of the cladding may advantageously correspond to the CTE of the core, i.e. likewise be in the region of 9.1×10^-6 1/K or have that exact value. The resultant numerical aperture may be in the range of 0.5 to 0.6, for example 0.55 or 0.58.

In a further system “G”, the core may have a glass of the following composition: PbO 40-50% by weight; SiO2 40-50% by weight; Na2O1-10% by weight; K2O 1-10% by weight; and As2O3 less than 1% by weight. The CTE of the core may be set in system “G” to 8.3×10^-6 1/K.

Alternatively, in system “G”, the core may have a glass of the following composition: SiO2 60-75% by weight, B2O3 10-15% by weight, Na2O 5-15% by weight, K2O 5-10% by weight, CaO 0.1-1% by weight, BaO 0.5-3% by weight, TiO2 more than 0-1.7% by weight; and Sb2O3 0-0.5% by weight.

In system “G”, the cladding may have a composition as follows: SiO2 71-77% by weight, B2O3 9-12% by weight, Al2O3 3.5-6% by weight, Na2O 5.5-8% by weight, K2O 0-0.5% by weight, Li2O 0-0.3% by weight, CaO 0-3% by weight, BaO 0-1.5% by weight, F 0-0.3% by weight, Cl- 0-0.3% by weight, and MgO+CaO+BaO+SrO together 0-2% by weight. The CTE of the cladding may be set to 4.9×10^-6 1/K. The numerical aperture may be in the range of NA=0.25 to 0.3. For example, the resultant NA may be 0.26 or 0.27.

In system “G”, an additional shell may be provided around the cladding. The shell may have a composition of SiO2 55-76% by weight; Al2O3 0-5% by weight; B2O3 0-5% by weight; Li2O+Na2O+K2O together 5-25% by weight; MgO+CaO+SrO+BaO+ZnO together 5-20% by weight; TiO2+ZrO2 together 0-5% by weight; P2O5 0-2% by weight. The CTE of the shell may be set to 9.1×10^-6 1/K.

In all the aforementioned compositions, the addition of customary refining agents is possible.

The SCR or MCR generally has a numerical aperture (NA). The NA is preferably greater than 0.3, more preferably greater than 0.4. For example, the NA may be set between 0.5 and 0.6. Alternatively or cumulatively, the NA of the SCR or MCR may be 0.9 or less, preferably 0.8 or less. In one working example, the NA may be 0.86.

The SCR or MCR may be configured to be resistant against acids. In this case, the SCR or MCR may have a chemical resistance class for acids of 1 or 2, for alkalis of 1 or 2, and if appropriate for water of 1 or 2.

The SCR or MCR may preferably have been inserted and/or bonded within the wall opening, i.e. in a vessel flange or pipe flange, for example. The bonding may be heat-curing and/or UV-curing. Alternatively or cumulatively, the wall opening, i.e., for example, the vessel flange or pipe flange, may have been shrunk onto the SCR or MCR. In yet another—optionally combinable—variant, the SCR or MCR may be hermetically bonded with a low-melting glass solder to the inside of the wall opening or directly to the vessel or pipe.

There may be a difference in the coefficient of thermal expansion (CTE) between the MCR and the body surrounding it, for example the main body or the vitrification, i.e., in particular, a ΔCTE between the respective materials used. It has thus been found to be advantageous when the ΔCTE is between 3 and 11 ppm/K. The CTE of the main body here is greater than that of the MCR.

The MCR may have mutually fused fibers to some degree or in some regions. Partial melting of fibers to some degree or in some regions may provide elevated integrity against fluid flow. For example, it is possible in this way to lower the capillary action for the fluid, such that the fluid is no longer able to move in the direction of the outside of the vessel along the individual fibers because of the capillary forces that build up. This therefore increases integrity, for example up to and including sterile integrity, or even fluid integrity. Integrity can also be further improved by the use or application of a cover glass. More preferably, the MCR is accordingly set up to prevent capillary action for the fluid volume.

For example, the partial melting may have the effect that, in the outer region of the outer fibers of the MCR, such individual fibers are collectively in one-piece form to some degree or in some regions. In other words, adjacent fibers collectively enter into a one-piece bond to some degree or in some regions, especially a fusion bond. For example, this can convert formerly round fibers to a hexagonal structure. A thermal treatment and optionally fusing of the fibers are effected, keeping the individual fibers intact. For example, this can be combined with pressure vitrification. The aim here is typically not a structural change in the individual fibers that goes deep into the individual fibers, since this can alter the optical properties of the fiber such that transmission of light is impaired or can even be made impossible. A further advantage that arises when an MCR is used is that, even if one or more marginal layers should be impaired in terms of their optical properties by the joining, this does not affect the transmission characteristics of the inner fibers. In other words, the marginal fibers offer a buffer layer or compensation layer, given sufficient dimensions, in order to prevent or alleviate, for example, damage by the joining process. The MCR may also have a fiber sheet formed by fusion or partial fusion of a multitude of individual fibers to one another, which should thus be regarded as a mutually bonded sheet in some regions or in part.

The feed-through coupling element usually has an end face facing the fluid volume. The end face preferably concludes flush with the wall or the main body. For example, flush conclusion of the end face of the feed-through coupling element can be achieved in that the end face has been removed or polished by means of an abrasive method. In other words, an original end face of the feed-through coupling element may at first surpass the wall or main body; in one working example, the length of the feed-through coupling element is greater than the thickness of the main body or wall. Thereafter, the feed-through coupling element that has already been inserted into the main body or the wall opening may then be removed, for example polished, in order to reduce the length of the feed-through coupling element to the surface of the main body or wall. The end face may, as already described, have a coating, especially a seal, where the coating or seal can then be applied after the material removal, i.e. for example the polishing.

The light transmission component as described in the preceding embodiments may additionally have an optical beam divider disposed on an outer face. Such a beam divider may be provided for separation of the incoming light from the outgoing light. This may especially be a polarizing beam divider.

The light transmission component as described in the preceding embodiments may also comprise a support element, especially set up for positioning against the feed-through coupling element, against the main body or against the wall. For example, the support element is positioned on the outside of the wall. The support element may be set up or provided to brace the feed-through coupling element against shear forces, for example if the length of the feed-through coupling element surpasses the wall, and especially protrudes on the outside.

In addition, the light transmission component may have a cooling device disposed on the outside of the light transmission component, especially in order to efficiently remove any amount of heat generated by incident radiative power loss and, for example, to protect the feed-through coupling element from damage or deformation. Such a cooling device may have cooling fins, or may provide liquid cooling.

The feed-through coupling element may additionally have a conical enlargement in order to improve hermeticity, especially oriented in the direction outside the wall or the vessel or pipe.

The feed-through coupling element may comprise imaging optics, especially inserted in the wall opening together with the feed-through coupling element.

The feed-through coupling element may also have a metallized finish on its circumference to establish a direct metallic join connection between feed-through coupling element and wall opening. For this purpose, it is possible to use stainless steels, for example austenitic, ferritic. It is also possible to use Inconel, molybdenum or titanium.

There may also be a solder glass disposed between the feed-through coupling element, for example an optical fiber rod, and the vessel opening. In other words, in the direction at right angles to the wall between the feed-through coupling element and an inner face of the opening, solder glass may be used to compensate for any manufacturing tolerances and/or to compensate for variances in shape of feed-through coupling element and/or the opening from a perfect fit, such as a perfect circular shape in particular, and/or to improve optical quality. On the other hand, it may be preferable for the shell glass of the feed-through coupling element to constitute the interface to the inside of the opening, especially the metal of the wall.

The feed-through coupling element may have been inserted into the wall opening by means of a compression glass seal. By means of the glass sealing or compression, the fibers may be densified, predominantly in the marginal region of the MCR.

With regard to the materials used in the feed-through coupling element, it is advantageous when the materials or material combinations release a small amount of substances, if any, to the fluid. For example, a low nickel leach rate is advantageous when the fluid observed includes organic or living parts, substances or materials, in order to avoid any influence, especially any harmful influence.

The light transmission component as described in the preceding embodiments may also comprise an index-adjusting intermediate piece. The index-adjusting intermediate piece may be disposed in the optical coupling and/or between the feed-through coupling element and the coupling light guide coupled thereto. The index-adjusting intermediate piece may comprise, for example, an immersion oil or immersion gel. For example, the index-adjusting intermediate piece may have been bonded to the feed-through coupling element or a coupled fiber with a refractive index-adjusted adhesive. It is also possible to use an immersion element, for example an immersion pad or an optically transparent cushion. Such an optically transparent cushion may additionally assume the function of a damping element for mechanical decoupling. The immersion element may also be provided by an index-adjusted, preferably permanently elastic, adhesive.

In one aspect of the present description, the light transmission component is used for monitoring or optical analysis of a fluid volume, i.e. of liquids in particular, in a vessel or pipe. The vessel or pipe may have been produced from or may comprise aluminum, metal such as a cast metal, stainless steel or glass fiber-reinforced plastic, especially for storage of chemical or pharmaceutical substances or of foodstuffs. Such substances may also comprise petrochemical substances such as, in particular, gasoline, diesel or kerosene. The vessel or the pipe or feed may then be a fuel vessel or a fuel-conducting conduit. Fields of use for this purpose include motor vehicles, ships, energy generation, aviation.

In a further aspect of the present description, the light transmission component is used for monitoring or optical analysis of a fluid volume, i.e. of liquids in particular, in disposable plastic vessels, especially for use in medical devices, for example in in vitro diagnosis systems, for example a virus tester, such as a Covid tester in the current global situation. A further example of medical devices in this field may include measurement of blood composition in dialysis equipment. The fluid volume may comprise, for example, a liquid or a gel.

In a further aspect of the present description, the light transmission component is used for undisrupted event monitoring of a fluid volume and/or for transmission of an optical signal, such as, in particular, for image transmission from a fluid volume or for conduction of light into the fluid volume.

Yet a further aspect of the present description relates to a wall measurement system comprising a light transmission component as defined in at least one of the embodiments described above, and also having a detector device, especially in the form of a detector head. The invention will be elucidated in detail hereinafter by working examples and with reference to the figures, with some identical and similar elements being given the same reference symbols, and where the features of the different working examples can be combined with one another.

### BRIEF DESCRIPTION OF THE FIGURES

The figures show:

FIG. 1 first embodiment of a system with a light transmission component,

FIGS. 2 to 5 modifications of the embodiment shown by FIG. 1 in various functional forms or embodiments,

FIGS. 6 and 7 further embodiments of a light transmission component with main body,

FIG. 8 schematic diagram of a feed-through coupling element as multicore fiber element (MCR)

FIG. 9 top view of an MCR,

FIG. 10 further top view of a further embodiment of an MCR,

FIG. 11 microscope image of an inserted and compressed MCR,

FIG. 12 graph of the relative signal level above a lateral offset,

FIG. 13 diagram of geometric coupling losses,

FIG. 14 diagram of marginal fiber losses.

### DETAILED DESCRIPTION OF THE INVENTION

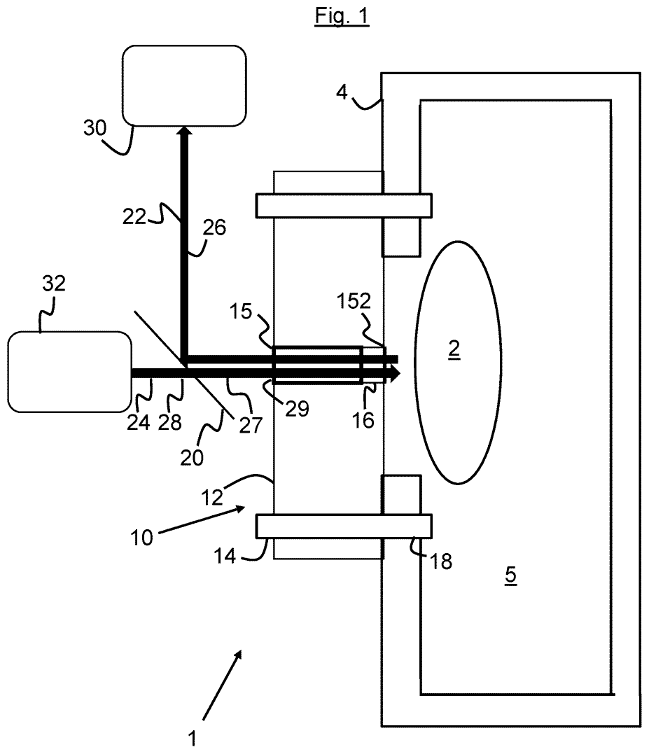

With reference to FIG. 1, a first embodiment of a system 1 is shown, which is set up for incidence of electromagnetic radiation 24 into a vessel 5. For this purpose, a lighting device 32 is connected by means of a coupling light guide 28 to the feed-through coupling element 15, such that the electromagnetic radiation 24 can be incident through the feed-through coupling element 15 into the vessel 5 and in particular into the fluid volume 2. A signal response 22 from the fluid volume 2, such as a fluorescence response, can be coupled into the feed-through coupling element 15, conducted through the feed-through coupling element 15 and, in this example, passed onward to a detector 30 by means of a coupling light guide 26.

The feed-through coupling element 15 is inserted into the main body 12. The main body 12 is connected in turn to the vessel 5 at a flange receiver 18 in the vessel wall 4 by means of securing means 14. At the end face 152 of the feed-through coupling element 15 is disposed a protective cap 16 for improvement of the resistance of the feed-through coupling element 15, for example to chemical or biological influences caused by the fluid volume 2.

In this example, a beam divider 20 is provided, in order to couple the incident radiation 24 out of the optical fiber 28 and the outgoing radiation 22 into the optical fiber 26, with both beam components coupled into a common coupling light guide 27 for conduction onward to the feed-through coupling element 15. In this way, it is possible to conduct incoming and outgoing radiation through just one feed-through coupling element 15.

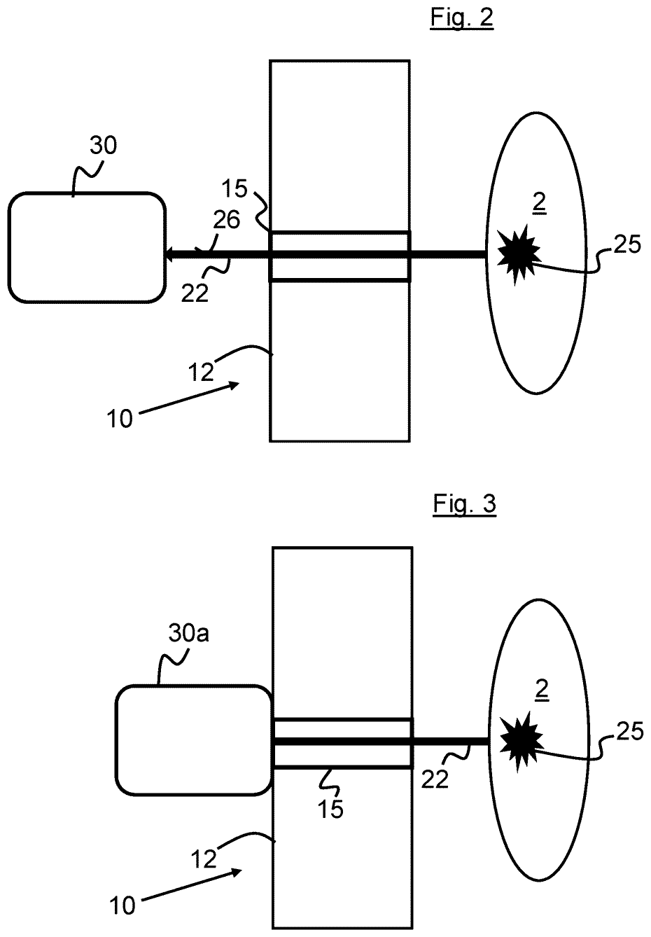

FIG. 2 shows, in merely schematic and reduced form, a modification of the system shown by FIG. 1, wherein an event detection system 1 is shown, in which an optical event 25 or pulse that takes place in a fluid volume 2 is coupled into the feed-through coupling element 15 and passed onward as an outgoing pulse 22 via a coupling light guide 26 to the detector 30. In yet a further development, as shown in FIG. 3, the system 1 may also be set up such that the sensor head 30a is coupled directly to the feed-through coupling element 15 without any need for a further coupling light guide, which may further increase the obtainable signal quality.

In yet a further schematic modification of the system 1 shown by FIG. 1, FIG. 4 shows an imaging system wherein optical image information 22a is coupled into the feed-through coupling element 15 from a fluid volume 2 and transferred to a detection system 30b, such as a camera. The feed-through coupling element 15 has, on its side 152 facing the fluid volume 2, an optical element 17 for improvement of the coupling of image information 22a into the feed-through coupling element 15. If necessary, the optical element 17 may be set up also to improve biological or chemical resistance to the properties of the fluid volume 2.

FIG. 5 shows a further schematic modification of the system 1 shown by FIG. 1, wherein a light source 32, such as a laser system in particular, couples a light signal 24, for example a laser pulse, into the coupling light guide 28 shown. The coupling light guide 28 is in turn connected to the feed-through coupling element 15, such that the light signal 24 can be coupled in at that point and transmitted through the wall 4. Within the vessel 5, a lighting target 25a, for example a photodiode, is arranged such that it can be illuminated by the light signal 24. For example, the introduction of the light signal 24 in the vessel 5 can trigger or prepare a sequence of events depending on the light signal 24, for example an independent measurement that takes place within the vessel 5.

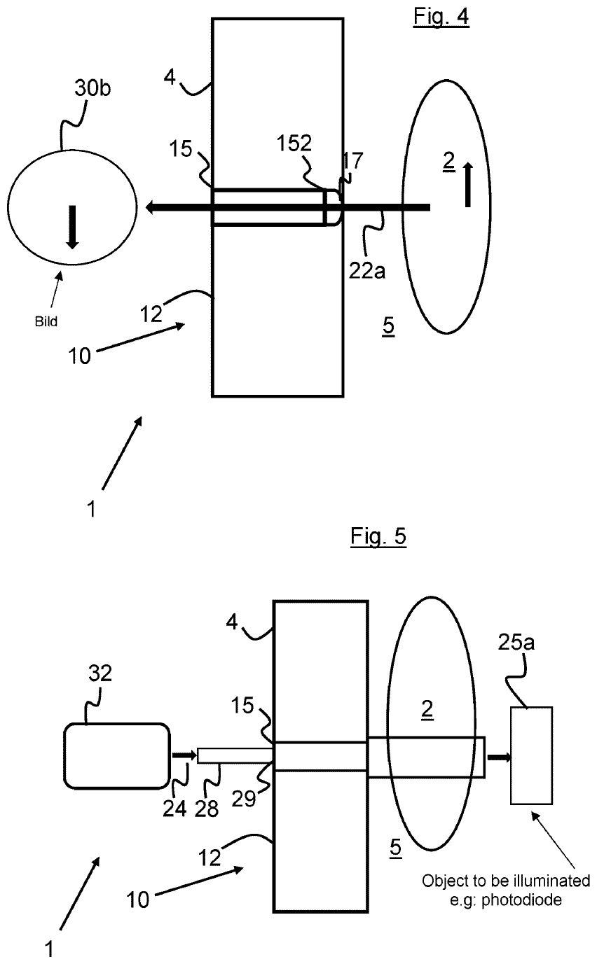

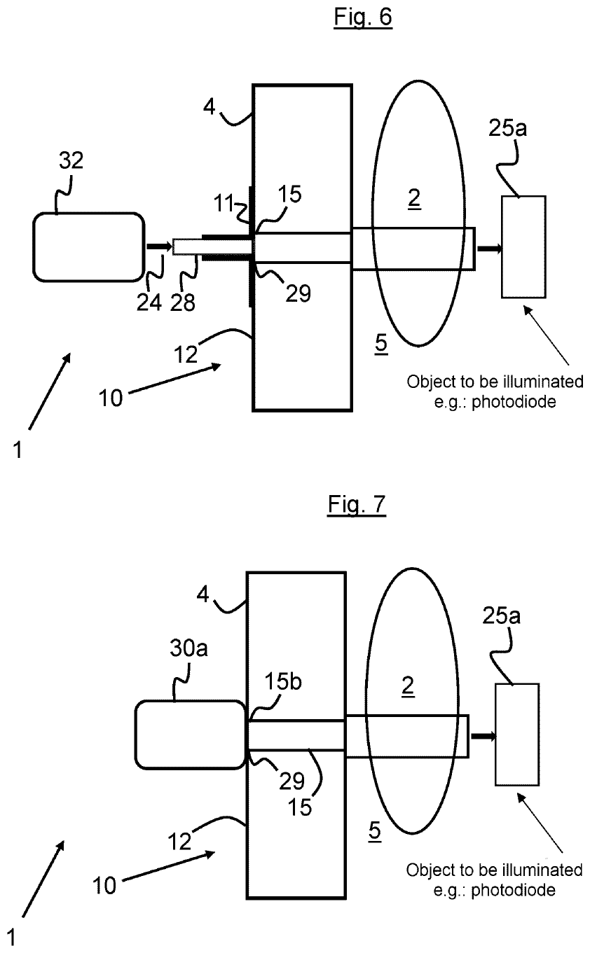

With reference to FIG. 6, a light transmission component 10 with main body 12 is shown, showing the feed-through coupling element 15 and an accommodation region 29 disposed thereon for accommodation of a coupling light guide (cf., for example, FIG. 5 or 8). A coupling light guide 26, 28 can, for example, be inserted or bonded or otherwise coupled into the accommodation region 29, for example even by screw connection. The feed-through coupling element 15 may have been inserted into the main body 12, for example with exploitation of the thermal expansion of the main material of the main body 12, for example stainless steel. The accommodation region 29 assumes the task and technical function of coupling for coupling of a coupling light guide 26, 28 to the feed-through coupling element 15. In order to improve handling and increase stiffness with respect to damage that can be caused to the light transmission component 10 under transverse forces, this embodiment is equipped with a support element 11, for example in the form of an upright collar 11 that partly surrounds the feed-through coupling element 15 and fully surrounds the accommodation region 29. The light transmission component 10 is flanged onto a vessel wall 4 of a vessel or pipe 5.

With reference to FIG. 7, a further embodiment of a light transmission component 10 is shown; in this embodiment, for example, a sensor head 30a is positioned directly on the main body 12 and can be optically connected to the feed-through coupling element 15. Particularly in the case of such optical connections by means of direct positioning or flange connection of the sensor head 30a directly to the far end 15b of the feed-through coupling element 15, it has been found to be a challenge in the context of defining the invention of the present description to obtain a sufficient signal strength for the measurement signal from the feed-through coupling element 15. But even in the case of coupling of a coupling light guide 26, 28, this has sometimes been difficult. The present description indicates various methods of improvement or solution for this purpose. A further development and improvement was found in a further embodiment in the context of the present description, which is presented beginning with FIG. 8. The given system is an optical element to be coupled, such as a sensor head 30a, or, in the case shown by FIG. 8, a coupling light guide 26 which is to be coupled to the feed-through coupling element 15. In the alignment of the optical element to be coupled, there are regular variances in that the full area of the end face 15b cannot be made to overlap with the optical element to be coupled. For example, there may be differences in diameter between the optical element to be coupled and the feed-through coupling element 15, or else a lateral offset. The signal losses observed here are immense; for example, they already mean a 20% signal loss in the case of a lateral offset of only 20 μm.

However, these signal losses are considerably smaller in the embodiment shown by FIG. 8. The feed-through coupling element 15 is designed in this form as a multicore fiber rod (MCR) having a multitude of individual fibers 154. A signal 25 can be coupled into a multitude of the individual fibers 154 of the feed-through coupling element 15. The light 25 emitted from the fluid volume at first hits all the fibers of the MCR 15. The fibers 154 that coincide with or overlap the coupling light guide 26 are utilized. The signal height is independent of the positioning of the MCR 15 or the coupling light guide 26. In the case of lateral movement, there is a change only in the individual fibers utilized, but not in the transmission pathway or the locations of coupling and analysis.

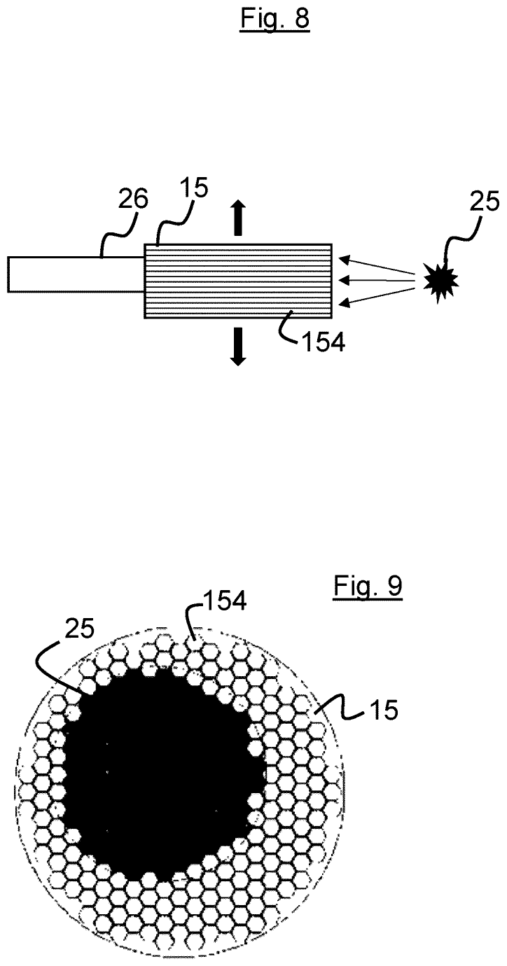

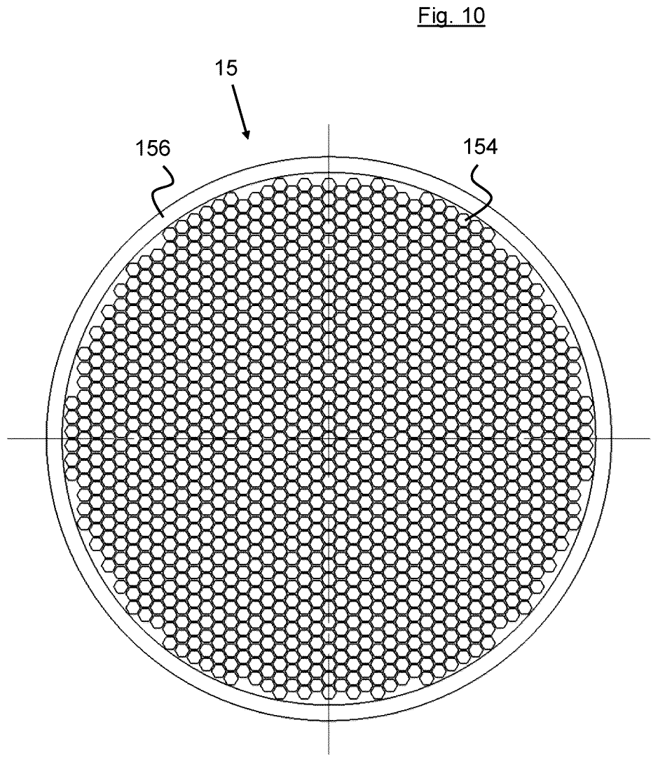

The coupling light guide 26, which is much smaller in this embodiment, overlaps with only some of the multitude of individual fibers 154. Nevertheless, the resultant signal quality is astonishingly good since there are no outcoupling losses that can result in loss of all the information or of the or a main portion of the signal under some circumstances. For example, it would even be harmless if the coupling light guide 26 were to be decoupled and recoupled, possibly in a slightly offset position. As illustrated by FIG. 9, the signal 25 is passed through the coupling light guide 26 only by a portion of the multitude of individual fibers 154. FIG. 10 shows an MCR 15 in a diagram, wherein the multitude of individual fibers 154 is enclosed by a common outer shell 156.

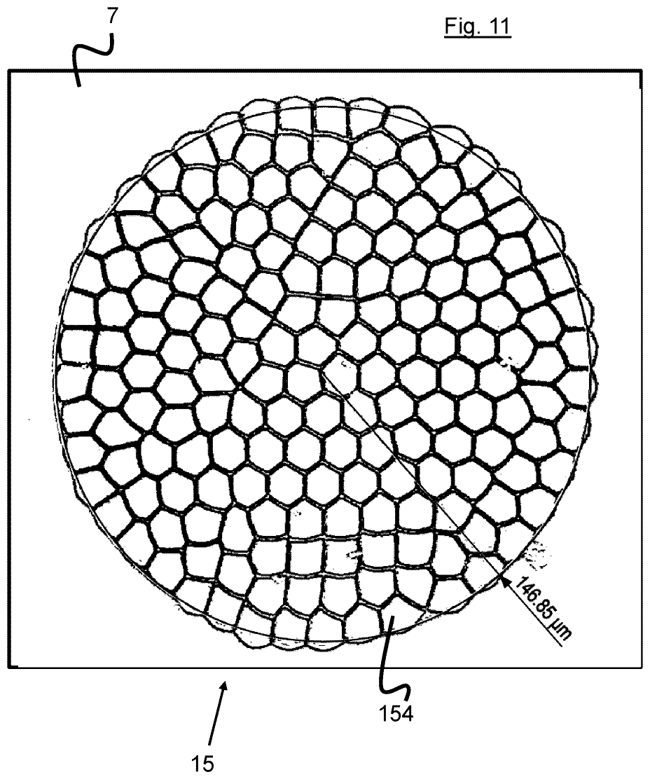

With reference to FIG. 11, a microscope image of an MCR 15 that has been vitreously pressed into a glass body 7 is shown, showing partly pentagonal and partly hexagonal deformation of the individual fibers 154 of the MCR 15. The densification of the fiber separation and simultaneous deformation of the individual fibers 154 which is achieved by means of the hot pressing leads to a further improvement in fluid integrity, since the capillary action for conduction of the fluid 2 between the individual fibers 154 of the MCR 15 is greatly lowered. In other words, the clear spaces that used to exist between the individual fibers 154 of the MCR 15 are greatly reduced in size, and the individual fibers 154 have adjusted their shape in the direction of greatest possible packing density. Adjustment of the hot process parameters can influence the partial melting of the outer fiber regions and hence the packing density of the individual fibers 154. It is thus also possible thereby to influence the fluid integrity of the MCR 15 and hence of the light transmission component.

For example, it is possible to establish a ratio of individual fiber diameter to core diameter—i.e. the diameter of the MCR 15—in the region of ⅛ or less. In the case of a core diameter of the MCR 15 of 200 μm, it is thus possible to choose an individual fiber diameter of each individual fiber 154 in the range of 10 to 20 or 25 μm, in order to be able to transmit a maximum signal intensity. The central region of the MCR 15—i.e. the region that reliably overlaps with the coupling light guide 26, 28—should be sufficiently large that all lateral and diameter tolerances can be covered. In the case of a diameter of 200 μm, for example, of the coupling light guide 26, 28 (core region), it is possible to choose a diameter of the active region of the MCR of, for example, 280 μm up to typically 320 μm, in order to obtain an optimal signal ratio. In the case of a diameter of 300 μm of the MCR 15 in this example, this corresponds to an offset tolerance of about 50 μm. In the case of a diameter of the MCR 15 of 350 μm, this would correspond, for instance, to an offset tolerance of about 100 μm.

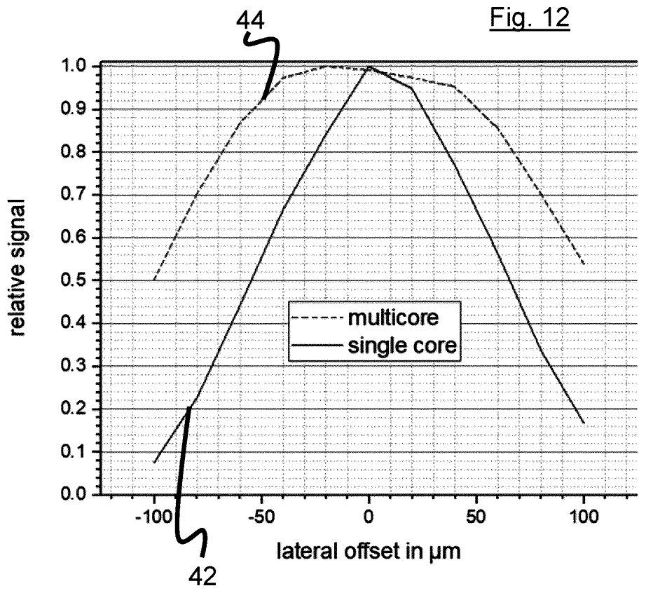

With reference to FIG. 12, the intensity progression of the electromagnetic radiation transmitted by the feed-through coupling element is shown in the case of a lateral offset between the feed-through coupling element and a coupling light guide coupled thereto. In the case of the single-core component as feed-through coupling element, graph 42 makes it clear that the signal intensity becomes much less even in the case of a comparatively small lateral offset. For example, graph 42 for an SCR with a lateral offset of 20 μm shows a signal loss of about 5%; in the case of a lateral offset of 50 μm, the signal loss is already in the region of more than 35%. In the case of the MCR, graph 44, by contrast, shows that the signal loss remains low even with a greater lateral offset. For instance, in the case of a lateral offset of the MCR with respect to the coupling light guide of 20 μm, the signal loss is in the region of only 2%, and in the case of a lateral offset of 50 μm only 10% or less.

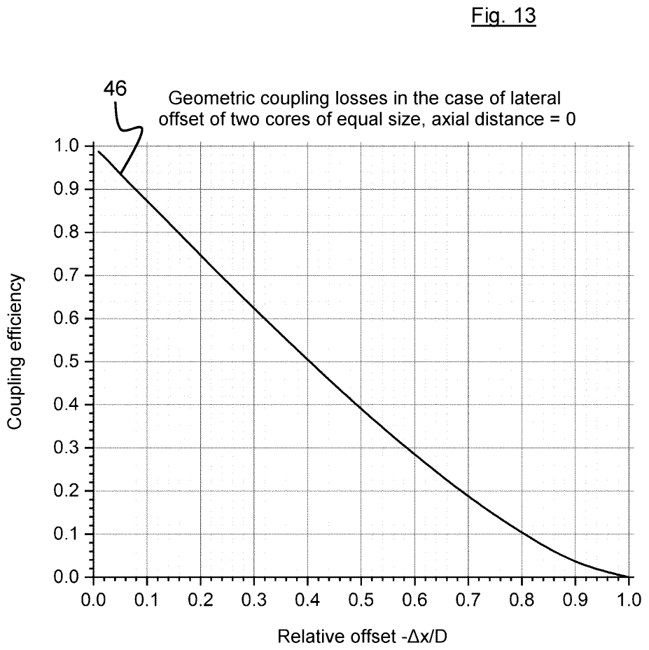

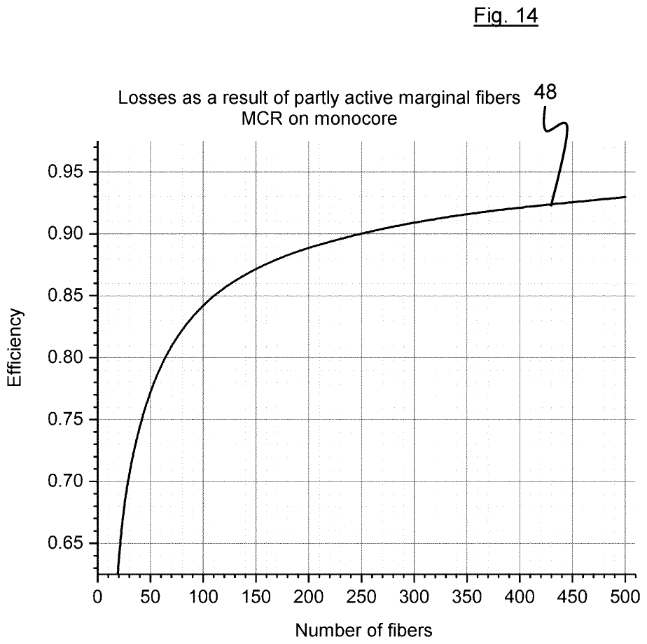

FIG. 13 shows coupling losses in the case of a lateral offset of two cores 15 of equal size that are arranged in contact with one another. This is a relative representation, i.e. the offset AX is based on the diameter D of the core 15 or cores. In the case of an illustratively chosen fiber diameter of 100 μm and an illustratively chosen offset of 20 μm, the relative offset is thus 0.2. In the case of a relative offset of 0.2, an efficiency of 75%, i.e. 25% loss, can be read off from FIG. 13. FIG. 14 shows geometry-related losses quantitively for the case of coupling of an MCR 15 to a round fiber 27. It is assumed here that the fibers involved in the transmission are those that are enclosed or cut by a circle having the fiber diameter. At the transition from the surface, which is no longer ideally round, to the fiber core, a portion of the light in the marginal fibers is lost. By way of approximation, the efficiency of the marginal layer fibers is assumed to be 50%, since the overlap is effectively random. Under these assumptions, the loss is calculated from half the proportion of marginal fibers in the total number of fibers and hence is dependent solely on the fiber count parameter. By way of example, with 200 individual cores of the feed-through coupling element 15 in the coupling region, the loss through the marginal fibers will be about 11%.

It will be apparent to a person skilled in the art that the embodiments described above should be considered to be illustrative and that the invention is not restricted thereto, but can be varied in various ways without leaving the scope of protection of the claims. It is also evident that the features, irrespective of whether they are disclosed in the description, the claims, the figures or otherwise, also individually define essential constituents of the invention, even if they are described jointly together with other features. In all figures, identical reference symbols denote identical features, and so descriptions of features that might be mentioned only in one figure or at least not with regard to all figures can also be applied to these figures with regard to which the feature is not described in the description.

### LIST OF REFERENCE SYMBOLS

1 system with light transmission component
2 fluid volume
4 wall, for example of a vessel or pipe
6 vessel
7 glass body
10 light transmission component
11 support element
12 main body
14 flange connector
10 14a flange connector
15 feed-through coupling element
15b fluid-remote end face
152 end face
154 individual fiber of the feed-through coupling element
15 156 sheath of the feed-through coupling element
16 cover, protective cap
17 optical element
18 flange
20 beam divider
22 outgoing radiation
22a image information
24 incident radiation
25 radiation event or pulse
25a object to be illuminated
26 optical fiber
27 coupling light guide
28 optical fiber
29 optical fiber receiver
30 detector or sensor
30a sensor head
30b camera
32 radiation source
42 multicore signal progression
44 single-core signal progression
46 coupling efficiency signal progression
48 fiber count signal progression

1. A light transmission component, especially for a sensor head (60a) or for attachment of a coupling light guide, for transmission of electromagnetic radiation, especially through a wall, comprising:
a feed-through coupling element set up for arrangement in a main body or in a wall opening for input coupling and divergence-free transmission of the electromagnetic radiation through the feed-through coupling element, especially through the wall, wherein the feed-through coupling element comprises or consists of a multicore fiber rod (MCR) and is designed to be tolerant to positional offset such that lateral positional offset between the feed-through coupling element and a light conducting component coupled therewith, such as a coupling light guide, of 10 μm or more.

2. A light transmission component, especially for a sensor head or for attachment of a coupling light guide for transmission of electromagnetic radiation, especially through a wall, comprising:
a feed-through coupling element set up for arrangement in a main body or in a wall opening set up for input coupling and divergence-free transmission of the electromagnetic radiation through the feed-through coupling element, especially through the wall,
wherein the feed-through coupling element has a numerical aperture of 0.21 or greater.

3. A light transmission component, especially for a sensor head or for attachment of a coupling light guide, for transmission of electromagnetic radiation, especially through a wall, comprising:
a main body which is insertable in a fluid-tight manner into a flange receiver in the wall or is releasably connectable thereto in a fluid-tight manner and has a main body thickness in a direction at right angles to the wall,
a feed-through coupling element that has been inserted into the main body and comes to rest in a main body opening for input coupling and divergence-free transmission of the optical signal through the wall,
wherein the feed-through coupling element has a coupling element length in the direction at right angles to the wall, and
wherein the main body thickness is identical to the coupling element length, such that the feed-through coupling element inserted into the main body opening does not surpass the main body thickness.

4. The light transmission component of claim 1, further comprising
an optical coupling for connection of the feed-through coupling element to a sensor disposed in the sensor head in particular, where the sensor is especially disposed outside a wall, and/or
wherein the main body has a flange connection for flanging to a counterpart flange connection disposed in the wall.

5. The light transmission component of claim 1,
further comprising a transparent cover, especially comprising quartz glass or plastic, and/or
comprising the transparent cover, wherein the transparent cover has been inserted into the wall opening, and especially concludes flush with the wall opening, and/or
comprising the transparent cover, wherein the transparent cover has been inserted into the wall opening by means of pressure vitrification, and/or
further comprising a converter element, especially as an organic or ceramic converter.

6. The light transmission component of claim 1,
wherein the feed-through coupling element is set up to transmit the electromagnetic radiation into a fluid volume or to introduce it from the fluid volume into the feed-through coupling element, and/or
wherein the feed-through coupling element is set up to provide similar optical attenuation for both feed-through directions, wherein the feed-through coupling element is especially of bidirectional design, and/or
wherein the feed-through coupling element is in a broadband setup for transmission of electromagnetic radiation of various wavelengths.

7. The light transmission component of claim 1,
wherein the light transmission component is configured to withstand a fluid pressure, especially a fluid pressure of 3 bar or more, and at the same time to ensure integrity, and/or
wherein the feed-through coupling element is designed to seal the wall opening in a fluid-tight manner.

8. The light transmission component of claim 2,
wherein the feed-through coupling element is designed to be tolerant to positional offset such that lateral positional offset between the feed-through coupling element and an optical fiber coupled therewith of 10 μm or more, results in a relative signal loss of 10% or less.

9. The light transmission component of claim 2,
wherein the feed-through coupling element comprises a flexible individual fiber, a single-core optical fiber rod (SCR) or a multicore fiber rod (MCR).

10. The light transmission component of claim 9,
wherein the flexible individual fiber or one individual fiber of the MCR has a thickness of 40 μm or less.

11. The light transmission component of claim 9,
wherein the SCR or MCR has a core constituent comprising optical glass, and/or
wherein the SCR or MCR has a cladding constituent.

12. The light transmission component of claim 9,
wherein the SCR or MCR has a numerical aperture (NA) of greater than 0.3.

13. The light transmission component of claim 9,
wherein the SCR or MCR has been inserted into and/or bonded to the vessel or pipe flange or the flange has been shrunk onto the latter or has been tightly bonded to the flange or directly to the vessel wall or the pipe flange with a low-melting glass solder.

14. The light transmission component of claim 9,
wherein the MCR includes fibers that have been fused to one another in portions or regions, and/or
wherein the MCR has a fiber sheet, and/or
wherein the MCR has been set up to prevent any capillary effect for the fluid volume.

15. The light transmission component of claim 1,
wherein the feed-through coupling element has an end face facing the fluid volume,
wherein the end face concludes flush with the wall or the main body, and/or
wherein the end face has a coating.

16. The light transmission component of claim 1,
further comprising a support element for positioning against the feed-through coupling element, against the main body or against the wall, to brace the feed-through coupling element against shear forces.

17. The light transmission component of claim 1,
further comprising a cooling device disposed on the outside of the light transmission component.

18. The light transmission component of claim 1,
wherein the feed-through coupling element has a conical enlargement to improve integrity.

19. The light transmission component of claim 1,
wherein the feed-through coupling element comprises imaging optics, inserted in the wall opening together with the feed-through coupling element.

20. The light transmission component of claim 1,
wherein the feed-through coupling element has a metallized finish on its circumference to establish a direct metallic join connection between feed-through coupling element and wall opening.

21. The light transmission component of claim 1,
wherein the feed-through coupling element has been inserted into the wall opening by pressure vitrification.

22. The light transmission component of claim 9,
further comprising an index-adjusting intermediate piece disposed in the optical coupling or between the feed-through coupling element and a coupling light guide coupled thereto.

23. The light transmission component of claim 9,
wherein solder glass has been inserted between the feed-through coupling element and an inner face of the opening in the direction at right angles to the wall in order to improve optical quality.

24. (canceled)

25. (canceled)

26. (canceled)

27. A wall measurement system comprising
a light transmission component of claim 1, and
a detector device.

28. A feed-through coupling element for a light transmission component of claim 1.
